(19) United States
(12) Patent Application Publication
(10) Pub. No.: US 2011/0268336 A1
(43) Pub. Date: Nov. 3, 2011

(54) SYSTEM FOR MONITORING MEDICAL ABNORMALITIES AND METHOD OF OPERATION THEREOF

(75) Inventors: Julia Dmitrieva, Bothell, WA (US); Jayne Louise Angela Armfield, Lynnwood, WA (US); Michael R. Vion, Lynnwood, WA (US)

(73) Assignee: KONINKLIJKE PHILIPS ELECTRONICS N.V., EINDHOVEN (NL)

(21) Appl. No.: 13/141,731

(22) PCT Filed: Dec. 11, 2009
(86) PCT No.: PCT/IB2009/055711

§ 371 Date: Jun. 23, 2011

Related U.S. Application Data
(60) Provisional application No. 61/140,111, filed on Dec. 23, 2008.

(51) Int. Cl. G06K 9/00

(52) U.S. Cl. 382/131

(57) ABSTRACT

A medical imaging system and method, the system including at least one controller which is configured to receive or receives first image information corresponding with one or more images acquired at a first time; receives second image information corresponding with one or more images acquired at another time; determines whether first coordinate information corresponding to one or more locations in the first image information has changed relative to second coordinate information corresponding to one or more locations in the second image information; and highlights the first image information based upon the result of the determination.

The present system relates generally to a medical imaging system and, more particularly, to an ultrasound imaging system with an automated acquisition technique, and a method of operation thereof.

Thyroid pathology commonly uses an ultrasound technique, known as an ultrasound thyroid assessment (UTA), to capture images of any possible nodules that may be present in a thyroid gland. When a nodule is detected, it is common practice to perform follow-up imaging and assessment at periodic intervals in order to manually determine whether the size of a specific nodule has increased, and, if so, at what rate. With regard to a specific nodule, if it is determined that the size of the nodule has increased over a given period of time, it is common practice to perform an invasive biopsy of the nodule.

During a typical UTA, when assessing a nodule, it is often difficult to determine whether the nodule is a new nodule or is a previously existing nodule. This can be due to variations in imaging and caliper techniques which are performed by imaging professionals such as, for example, sonographers. Unfortunately, these variations may lead to unnecessary biopsies, which are invasive, inconvenient, uncomfortable, time-consuming, and/or costly.

Typically, a UTA is performed using a series of two-dimensional (2D) images. To obtain these images, the position of an ultrasonic transducer must be varied relative to a patient's neck so that desired views of various desired segments which correspond with the sagittal and axial (or transverse) planes of the anatomy may be captured. During the UTA, a sonographer must evaluate the sagittal and/or axial planes of thyroid lobes and place calipers on all recognized nodules. Further, when multiple nodules are found, the sonographer must keep track of, and label, each nodule in a corresponding UTA report. Further, to ensure that similar results are obtained in successive UTAs, image parameters must match image parameters of previous UTAs. This process must typically be manually performed, and is time consuming and prone to error. Further, during typical UTAs of patients who have multiple nodules, sonographers may lose track of these nodules and/or their measurements and, as a result, generate an inaccurate UTA report. Further, sonographers often mislabel and/or enter incorrect measurements related to one or more nodules in the UTA report. Therefore, the generated reports may have inaccurate and/or incorrect information. For example, images and/or nodules may be mislabeled and caliper measurements may be incorrect. Accordingly, the generated reports may be difficult or impossible to analyze.

Accordingly, when analyzing these reports, radiologists must typically determine whether the reports are accurate before a further analysis can be made. Further, to properly analyze the reports, radiologists must spend valuable time looking for corresponding sagittal and axial (or transverse) measurements of a nodule and are often unable to determine the location of a lesion when annotations and/or measurements are missing and/or incorrect.

Further, as medical professionals may rely upon current and previous reports to determine whether nodules are new and/or have grown, if a previous report is unavailable and/or contains inaccurate information, it may be difficult or impossible to determine a nodule or lesion is new and/or has grown. As used herein, the term “lesion” may refer to an enlarged portion of the thyroid gland that may correspond with a tumor, a mass, a lump, a nodule, a node, a growth, an abnormality, etc. Accordingly, a biopsy may have to be performed to gather additional information about the nodule. This can be inconvenient for a patient who must undergo the biopsy.

Accordingly, there is a need for a system and/or a method for monitoring thyroid lesions (which may include, for example, nodules or other abnormalities) that can overcome the disadvantages of prior art systems by obtaining the data quickly using two-dimensional (2D) or three-dimensional (3D) techniques, and storing 2D or 3D volumes of data, corresponding to 2D or 3D acquired images, for the analysis of required planes by automated software. The software may subsequently match corresponding volumes and determine if a lesion has changed in size during a period of time. Also, when it is determined that a lesion has changed in size over time, the system may mark or otherwise highlight a corresponding lesion or image frame using, for example, a predetermined color such as, a red tint. Further, if it is determined that the size of a certain lesion has not changed during a certain period of time, the system may highlight the lesion using, for example, a green tint. Accordingly, a professional such as, for example, a radiologist, may easily and accurately provide a diagnosis of a thyroid using a UTA report created in accordance with the present system. Further, the present marking system may increase the ease with which a lesion may be observed and/or provide a visual aid when managing the lesion such as may be done during a biopsy, etc.

Further, there is a need for a system and a method to automate an image-capture process which can be used to capture, process, and record medical image information.

Thus, according to a first aspect of the present system and method, there is disclosed a thyroid lesion auto reporting program which overcomes the disadvantages of the prior art and can easily and conveniently capture and record image information using a protocol which may be specific to a particular anatomical location of an organ or vessels (e.g., the thyroid gland, kidney, testes, breast, uterus, ovaries, liver, spleen, heart, arterial or venous system, etc.) It is another aspect of the present system and method to automatically report a location of a lesion, provide a measurement of the lesion, and/or determine whether the lesion has changed. Further, it is another aspect of the present system to report the determination, and/or save this information in a database.

The present system program may be compatible with existing imaging systems such as, for example, imaging systems which incorporate a Smart Exam™ protocol.

Accordingly, by having an automated image-capturing and -reporting routine, the time professionals such as, for example, radiologists spend evaluating and diagnosing image information related to a patient can be reduced. Additionally, by saving time, costs can be reduced. Moreover, misdiagnosis can be reduced by ensuring that proper examination and reporting procedure is performed.

One object of the present systems, methods, apparatuses and devices is to overcome the disadvantages of conventional systems and devices. According to one illustrative embodiment, a medical imaging system includes at least one controller which may be configured to: receive first image information corresponding with one or more images acquired at a first time and second image information corresponding with one or more images acquired at a second time.

The controller may also determine whether first coordinate information corresponding to one or more locations in the first image information has changed relative to second coordinate information corresponding to one or more locations in the second image information and/or highlight the first image information based upon a result of the determination. The system may further include an ultrasonic probe configured to acquire information related to the first image information. Further the one or more images in the first image information may include a sequence of images having at least two images which correspond with planes that are orthogonal to each other. Further, the one or more images acquired at the first time and/or the second time may correspond with a sequence of images.

According to the present system, the controller is may be configured to determine whether a caliper input has been requested and/or configured to coordinate information corresponding to the one or more locations in the first image information and/or the second image information. The coordinate information may be based upon calculated image contour information.

The controller may be configured to determine a rate of growth of one or more of one or more locations in the first image information. Further, the controller may be configured to associate a first highlight with the first image information when it is determined that the first coordinate information corresponding to one or more locations in the first image information has changed relative to the second coordinate information corresponding to one or more locations in the second image information. Moreover, the controller may be configured to associate a second highlight different from the first highlight with the first image information when it is determined that that the first coordinate information corresponding to one or more locations in the first image information has not changed relative to second coordinate information corresponding to one or more locations in the second image information.

According to another aspect of the present system, there is disclosed an image processing method performed by one or more controllers, the method may include one or more acts of: receiving first image information corresponding with a one or more images acquired at a first time; receiving second image information corresponding with one or more images acquired at a second time; determining whether first coordinate information corresponding to one or more locations in the first image information has changed relative to second coordinate information corresponding to one or more locations in the second image information; and highlighting the first image information based upon a result of the determination.

The method may also include the act of acquiring information related to the first image information from an ultrasonic probe. Moreover, the one or more images acquired at the first time may correspond with a first sequence of images, and the one or more images acquired at the second time may correspond with a second sequence of images. The second time may correspond with a day/date that is later than the first time. The method may also include the act of generating a three dimensional image volume using information from two or more images which correspond with planes that are orthogonal to each other. Further, the two or more images may be selected from the one or more images are acquired at the first time and/or the one or more images acquired at the second time.

The method may also include the act of determining whether a caliper input has been requested. The method may also include the act of determining coordinate information corresponding to the one or more locations in the first image information and/or the second image information. The method may also include the act of calculating image contour information and/or determining a rate of growth of the one or more locations in the first image information.

The method may also include the act of associating a first highlight with the first image information when it is determined that the first coordinate information corresponding to the one or more locations in the first image information has changed relative to the second coordinate information corresponding to the one or more locations in the second image information. The method may further include the act of associating a second highlight, different from the first highlight, with the first image information when it is determined that the first coordinate information corresponding to one or more locations in the first image information has changed relative to second coordinate information corresponding to one or more locations in the second image information.

According to another aspect of the present system, there is discloses an application embodied on a computer readable medium configured to receive image information from an ultrasonic probe, the application, may include code which causes a controller to: receive first image information corresponding with one or more images acquired at a first time; receive second image information corresponding with one or more images acquired at second time; determine whether first coordinate information corresponding to one or more locations in the first image information has changed relative to second coordinate information corresponding to one or more locations in the second image information; and highlight the first image information based upon a result of the determination.

Moreover, the code may control the controller to associate a first highlight with the first image information when it is determined that the coordinate information corresponding to one or more locations in the first image information has changed relative to coordinate information corresponding to one or more locations in the second image information. Further, the code may control the controller to associate a second highlight, different from the first highlight, with the first image information when it is determined that that the first coordinate information corresponding to one or more locations in the first image information has not changed relative to the second coordinate information corresponding to one or more locations in the second image information.

Further areas of applicability of the present apparatuses, devices, systems and methods will become apparent from the detailed description provided hereinafter. It should be understood that the detailed description and specific examples, while indicating exemplary embodiments of the systems and methods, are intended for purposes of illustration only and are not intended to limit the scope of the invention.

These and other features, aspects, and advantages of the apparatuses, devices, systems, and methods (hereinafter systems and methods) of the present invention will become better understood from the following description, appended claims, and accompanying drawing where:

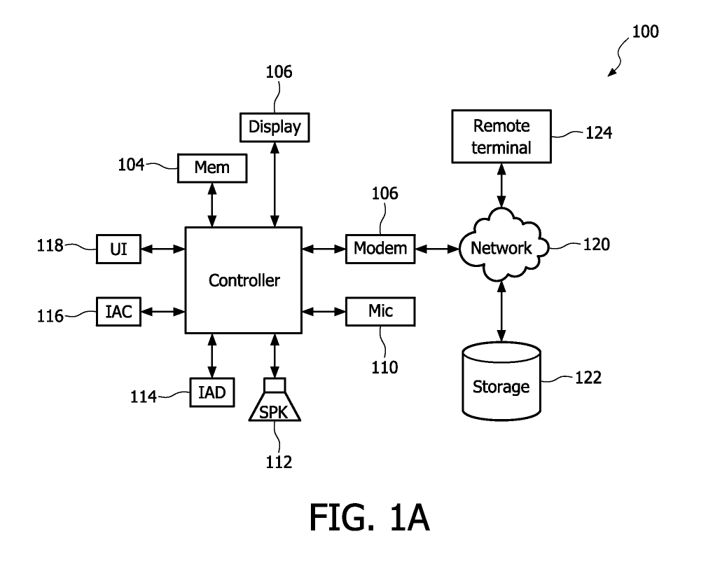

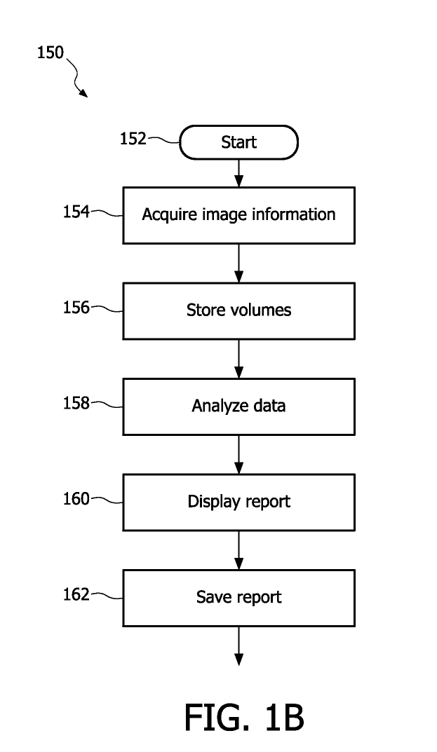

FIG. 1A is a schematic view of an embodiment of the image-capturing system according to the present system;

FIG. 1B is a flow chart illustrating a process performed according to an embodiment of the present system;

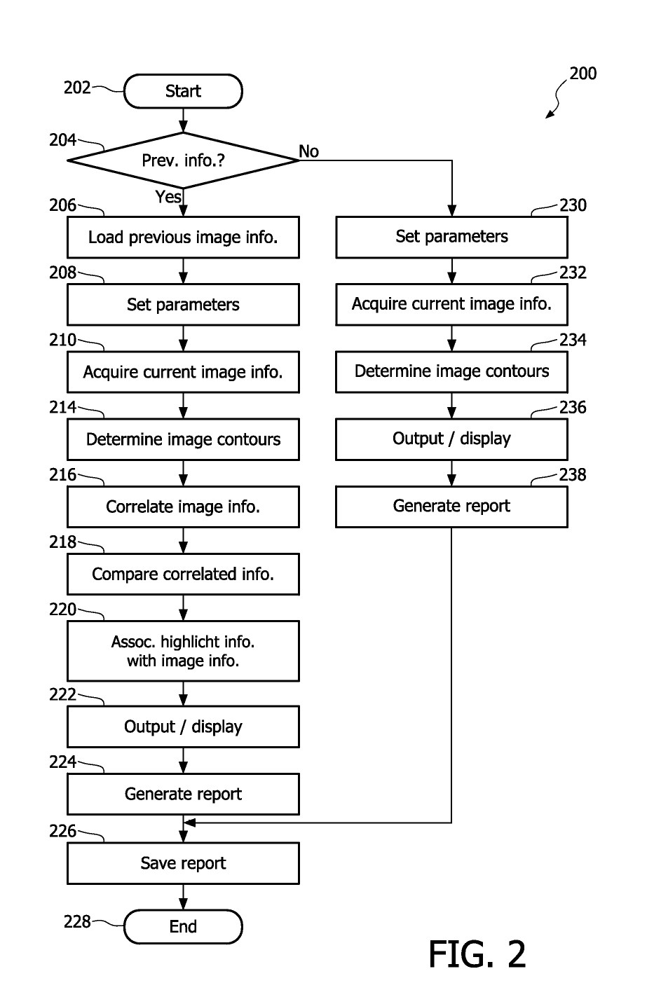

FIG. 2 is a flow chart corresponding to a process performed by an embodiment of the present system;

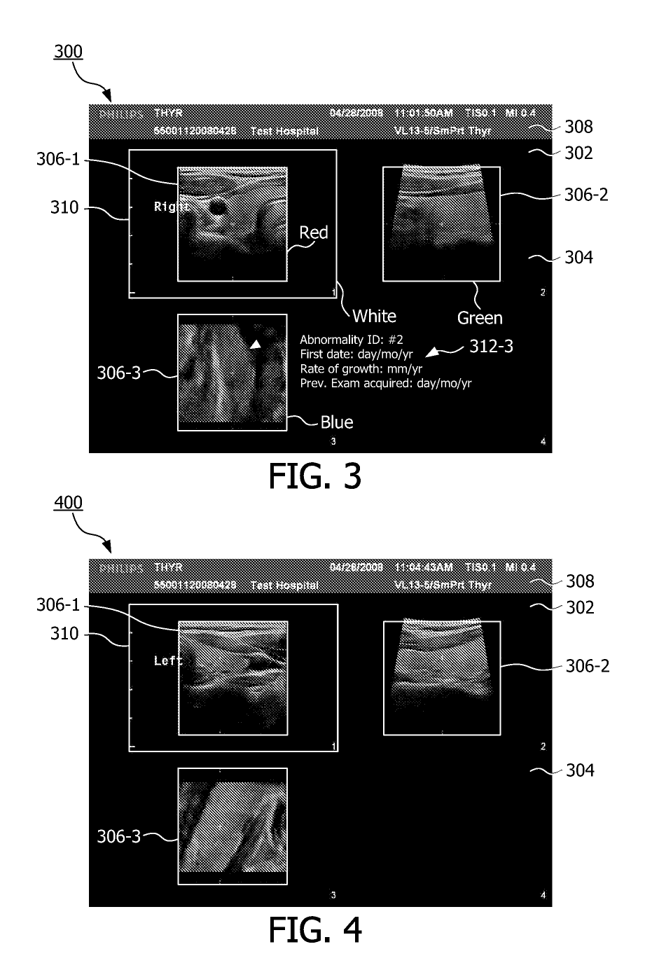

FIG. 3 is a screen shot illustrating an image display according to the present system;

FIG. 4 is a screen shot illustrating another image display according to the present system;

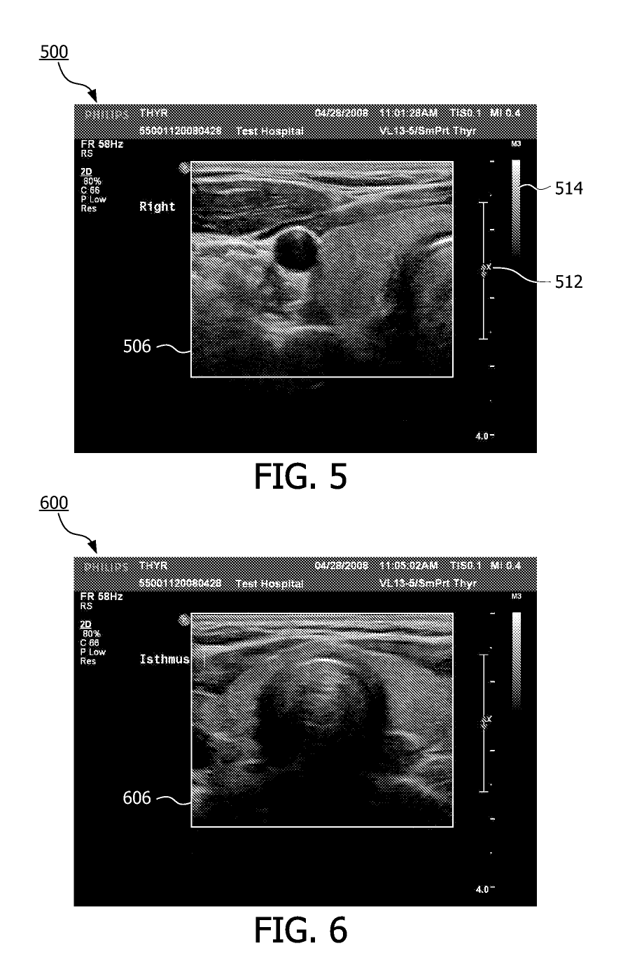

FIG. 5 is a screen shot illustrating a further image display according to the present system; and

FIG. 6 is a screen shot illustrating yet another image display according to the present system.

The following description of certain exemplary embodiments is merely exemplary in nature and is in no way intended to limit the invention or its applications or uses. In the following detailed description of embodiments of the present systems and methods, reference is made to the accompanying drawings which form a part hereof, and in which are shown by way of illustration specific embodiments in which the described systems and methods may be practiced. These embodiments are described in sufficient detail to enable those skilled in the art to practice the presently disclosed systems and methods, and it is to be understood that other embodiments may be utilized and that structural and logical changes may be made without departing from the spirit and scope of the present system.

The following detailed description is therefore not to be taken in a limiting sense, and the scope of the present system is defined only by the appended claims. The leading digit(s) of the reference numbers in the figures herein typically correspond to the figure number, with the exception that identical components which appear in multiple figures are identified by the same reference numbers. Moreover, for the purpose of clarity, detailed descriptions of certain features will not be discussed when they would be apparent to those with skill in the art so as not to obscure the description of the present system.

In one embodiment, there is provided a system, application, and/or method for systematically performing a medical assessment of an organ, such as, for example, a thyroid, so as to standardize medical image reporting, which can reduce evaluation times and errors. Accordingly, costs for acquiring, reporting, and/or evaluating medical images can be reduced.

A schematic view of an embodiment of an image-capturing system 100 according to one embodiment of the present system is illustrated in FIG. 1A. The image-capturing system 100 may include one or more of a controller 102, a memory 104, a display 106, a modem 108, an audio input device (MIC) 110, an audio output device (SPK) 112, an image acquisition device (IAD) 114, an image acquisition control (IAC) device 116, a user interface (UI) 118, a network 120, a remote storage device 122, and a remote device or terminal 124.

The controller 102 controls or is configured to control the overall operation of the image-capturing system 100 and may include one or more controllers which may be located at the same location or at different locations. For example, one or more of the controllers may be located at the remote device 124. Accordingly, certain actions performed by one or more of the processes of the present invention may be performed at the remote device.

The memory 104 may interface with the controller 102 and may store or be configured to store programs and data which may be read and/or stored by the image-capturing system 100. The memory 104 may include one or more of a hard disc, a read-only memory (ROM), a random-access memory (RAM), a flash drive, an optical drive, and/or another suitable memory device. Further, the memory 104 may include different types of memory and may be located at a plurality of locations. The memory may include the programs and/or data created by operation of the present systems, devices, and/or methods.

The display 106 may display information under the control of one or more controllers such as, for example, the controller 102. The display 106 may include any suitable display such as, for example, cathode ray tubes (CRTs), liquid crystal displays (LCDs), plasma displays, touch screens, etc. The display 106 may include multiple displays which may be located at different locations. The display 106 may also receive user inputs.

The modem 108 may operate under the control of the controller 102 and may transmit and/or receive data to/from the controller 102 to various locations via, for example, the network 120. The modem 108 may include any suitable modem or modems and may communicate via a wired and/or a wireless link.

The audio input device 110 (MIC) may include any suitable device for inputting audio information, such as, for example, a microphone and/or transducer. The audio input device 110 may transmit received audio information to the controller 102 via, for example, a coder/decoder (CODEC). The audio input device 110 may also be located at a remote location and may transmit information via, for example, the network 120. The audio input device 110 may receive audio inputs from, for example, a user. A voice recognition program may then translate these commands for use by the controller 102. A translation program such as, for example, a speech-to-text converter, may be used to convert sound information (e.g., a user's voice, a command, etc.) into text or other data.

An audio output device 112 (SPK) may output audio information for a user's convenience. The audio output device 112 may include a speaker 112 and may output audio information received from, for example, the controller 102, via, for example, the CODEC. Further, a translation program may translate a parameter (e.g., text, data, etc.) to be visually output so that the parameter can be output via the speaker 112.

The image acquisition probe 114 may obtain desired information under the control of the controller 102 and transmit this information to the controller 102 where it may be processed. The image acquisition probe 114 may include one or more transducer arrays, etc. For example, the present system may include a transducer such as, for example, a C5-1 transducer by Philips Electronics.

The image acquisition control (IAC) device 116 may be controlled by the controller 102 and may include stabilization control devices (e.g., array stabilizers, etc.) which may control the position of the image acquisition probe (IAD) 114. For example, the IAC device 116 may include one or more devices to control the yaw, pitch, and/or roll of, for example, one or more transducer arrays relative to a handle, etc. Accordingly, the IAC device may control the position of the one or more transducer arrays about an x, y, or z axis and/or reduce undesired harmonics, vibration, etc. Further, the IAC device 116 may include a counter balance, a motor, a control system, etc., to control vibration, etc., of the one or more transducer arrays.

The user interface (UI) or user input device 118 may receive user inputs and transmit these inputs to, for example, the controller 102. The user input device 118 may include any suitable input device which can receive a user input, such as, a keyboard, a mouse, a touch pad, a track ball, a pointer, a digitizer, a touch screen, a finger-print reader, etc. Further, the user input device may include a biometric reader for inputting biometric information such as, for example, the fingerprint reader, an iris reader, etc.

The network 120 may include one or more of a local area network (LAN), a wide area network (WAN), the Internet, an intranet, a proprietary network, a system bus, and/or other transmission devices (active and/or passive) which may transmit information between various devices of the image-capturing system 100. The network 120 may operate using any suitable transmission scheme.

The remote storage device 122 may include any suitable memory device which can store information as required by the image-capturing system 100. Accordingly, the remote storage device 122 may include memory devices such as those described with reference to the memory 104. Further, the remote storage device may include a redundant array of independent disks (RAID) and/or other storage configurations. Moreover, the remote storage device 122 may include, for example, a storage area network (SAN). The remote storage device 122 may transmit/receive information to/from the controller 102 via the network 120 and/or the modem 108.

A process for capturing images according to an embodiment of the present system will now be described. A flow chart corresponding to a process performed by an embodiment of the present system is shown in FIG. 1B. A process 150 may be controlled by one more computers communicating directly and/or over a network. The process 150, as well as other process according to the present methods, may be performed by execution of instructions embodied on a computer readable medium (such as the memory 104) by a processor, such as the controller 102. The processor or controller 102 may be an application-specific or general-use integrated circuit(s). Further, the processor 102 may be a dedicated processor for performing in accordance with the present system or may be a general-purpose processor wherein only one of many functions operates for performing in accordance with the present system. The processor 102 may operate utilizing a program portion, multiple program segments, or may be a hardware device utilizing a dedicated or multi-purpose integrated circuit.

The process 150 may include one or more of the following steps, acts or operations. Further, one or more of these steps, acts, or operations may be combined and/or separated into sub-steps, sub-acts, or sub-operations, if desired. In act 152, a monitoring process such as, for example, a thyroid lesion monitoring automation process begins and proceeds to act 154.

In act 154, an image acquisition process is performed to acquire current image information. Before acquiring image information, the system may output (e.g., via the display) a message to a user to obtain, for example, three sweeps using an acquisition probe such as, for example, a VLI3-5™ Thyroid TSI, where TSI is a commonly-known VLI3-5™ for thyroid imaging in a transverse plane, with the mid part of the isthmus being displayed, for example, on the right (for the right thyroid lobe), left (for the left thyroid lobe) or the middle (for isthmus evaluation) of the screen. All necessary images should be acquired in act 154, however, act 154 may be repeated at other times to acquire other necessary images. After completing act 154, the process continues to act 156.

In act 156, the current image information (e.g., an image volume) may be stored in, for example, a local memory, a database, or other suitable memory. After completing act 156, the process may continue to act 158.

In act 158, the process may use an image processing routine to analyze/compare the current image information and the previous image information that was acquired previously (e.g., last month, last year, etc.). For example, according to the process, a user may measure lesions automatically by using an auto stack contour routing method (e.g., in QLAB™) or manually (e.g., by using a caliper). The measurements, location, and/or contours of lesions may then be defined and/or recorded by assigning, for example, x, y, and/or z coordinates to all caliper locations. This information may then be stored in a database or other suitable area for later use.

This information may then be used at a later time, such as, for example, when conducting a follow up imaging technique. For example when a patient has a successive thyroid monitoring examination in which current image information is acquired, the image information acquired in one or more previous examinations, may then be retrieved or downloaded from the memory 104 or storage 122, and analyzed using any suitable image processing application, such as, for example, QLAB™, which may determine certain imaging parameters such as depth, focal zone location compression, contours, and/or x, y, and z coordinates, velocity information from Doppler techniques, echo intensity. One or more of such imaging parameters may be matched in a current examination to similar imaging parameters used in one or more previous thyroid monitoring exams. This process may be performed by a user or by the system automatically. Accordingly, the system may access image parameter information to obtain information related to image parameters used in one or more previous thyroid monitoring exams.

An auto stack contours method (e.g., in QLAB™) may be applied and location information such as, for example, x, y, and/or z coordinates of certain locations (e.g., corresponding with, for example, lesions, nodules, nodes, etc.) of image information corresponding with the previous examination, may be compared with corresponding information of image information associated with the current examination.

An auto correlation and/or superimposition of image information process may be performed using a suitable image processing program such as, for example QLAB™

As a result of the comparison, if the process determines that coordinates of, for example, a lesion match in the previous image information (e.g., of a previous examination) with the current image information (i.e., which may be indicative of a lesion which has not grown or otherwise changed), the process may highlight a corresponding image (e.g., an image which includes the lesion) using, for example, a green border which may appear around an image volume demarcating the lesion. However, if the process determines as a result of the comparison that the coordinates do not match, the process may highlight the corresponding image using a red border to visually inform a user, such as a radiologist, that the lesion has changed. The coordinates may refer to caliper location coordinates and/or image contour coordinates.

After act 158, the process may continue to act 160.

In act 160, the process may display a corresponding report for a user's convenience. When the report is displayed, a user may enter additional text and/or annotations as necessary.

According to the present system, the system may extrapolate numeric values for the current and/or previous measurements in any position defined. The corresponding measurements may then be stored in the x, y, and/or z format during the analysis of the auto stack contours. Further, a manual “manual override” option may be provided for the user to enter information corresponding to a lesion such as, for example, lesion definition, lesion identification, etc., at any time.

After completing act 160, the process may continue to act 162.

In act 162, the process may generate a report and/or save the image information and any corresponding information (e.g., lesion identification, lesion locations, lesion definitions, user information, date information, patient information, etc.) for later use and/or analysis, in any suitable location such as, for example, a database, etc.

A process 200 for capturing images according to another embodiment of the present system will now be described. A flow chart corresponding to the process 200 performed by an embodiment of the present system is shown in FIG. 2. The process 200 may be controlled by one more computers communicating directly and/or over a network. The process 200 may include one or more of the following steps, acts or operations. Further, one or more of these steps, acts, or operations may be combined and/or separated into sub-steps, sub-acts, or sub-operations, if desired. In act 202, a thyroid lesion monitoring automation process begins and proceeds to act 204.

In act 204 it is determined whether previous image information exists. If it is determined that previous image information exists, the process continues to act 206. However, if it is determined that previous image information does not exist, the process continues to act 230. The previous image information may correspond with image information which was previously generated. The process may determine whether previous image information exists by retrieving data related to a patient's identification (ID) such as, for example, an alpha/numeric code or biometric information.

In act 206, the process loads previous image information from, for example, a database (e.g., the remote storage device 122) via, for example, a network (e.g., the network 120) or other suitable transmission system. The process may then extract previous image parameters and set current image parameters in accordance with the previous image parameters. The image parameters may include, for example, depth, focal zone location compression, focal zone location and number, compression, contours, and/or x, y, and z coordinates, velocity information from Doppler techniques, echo intensity etc.

The previous image information may include data which corresponds to image information of orthogonal plane views such as, for example, a Right Lobe Transverse—superior (upper) and a Right Lobe Sagittal—(upper) view images. Further, the previous image information may correspond with image information which was acquired during a certain time period. For example, the previous image information may correspond with image information which was acquired during the previous year, two years, a predetermined period that lies between certain dates, before certain times, etc. Moreover, information corresponding with multiple time periods may also be acquired. For example, the previous image information may include image information which corresponds with one or more previous acquisition times (e.g., summer and fall of 2006). The user and/or the system may determine and/or set desired time periods. After completing act 206, the process may continue to act 208.

In act 208, the process may set image acquisition parameters for the acquisition of current images, in accordance with the retrieved parameters (e.g., the previous image parameters that were extracted in act 206). After completing act 208, the process continues to act 210. It is also envisioned that a user may change one or more image acquisition parameters, if desired. Further, if it is determined that certain image acquisition parameters between current images and, for example, previous images do not match, the process may perform an interpolation process as necessary so that certain parameters (e.g., image acquisition parameters, user defined parameters, etc.) or image information may be matched.

In act 210, current image information may be acquired in accordance with image acquisition parameters, user defined parameters, etc., that were previously set. The current image information may be acquired using, for example, an image acquisition probe (e.g., 114), or other suitable transducer. However, it is also envisioned that the image information may be loaded from a database (e.g., the remote storage device 122) via, for example, a network (e.g., the network 120) or other suitable transmission system. The system may output (e.g., via a display, a speaker, etc.) information related to an image or image sequence to be captured. For example, a user may be requested to input a certain image such as, for example, a Right Lobe Transverse—superior (upper pole) view which corresponds with the first image in the sequence shown in Table 1. The system may then associate a corresponding label, and display, and/or store this information in accordance with the corresponding image (e.g., Right Lobe Transverse—superior (upper pole)) view. Thereafter, if a user requests a caliper input before the next image (e.g., the “Right Lobe Transverse—mid pole”) view in the sequence is acquired, the system may change the order sequence, such that that image which is orthogonal to the current image (e.g., the Right Lobe Sagittal—lateral view) may be selected for the next image. That is, the view is changed from the current image of Right Lobe Transverse—superior to Right Lobe Sagittal—superior, where Sagittal is orthogonal to Transverse but the location in thyroid remained the same, namely, Right Lobe—superior/lateral.

However, if a user does not request a caliper mode input, the next image may be the following image in the sequence shown in, for example, Table 1 (e.g., the “Right Lobe Transverse—mid pole”). The system, may output a request indicating the next image via, for example, the display, a speaker, etc., and await acquisition of the next view. The process may associate labels and/or annotations with corresponding images. For example, a “Right Lobe Transverse—superior (upper pole)” label and/or identification may be associate with a corresponding image.

TABLE 1

| SEQUENCE | IMAGE |
|---|---|
| 1 | Right Lobe Transverse - superior (upper pole) |
| 2 | Right Lobe Transverse - mid pole |
| 3 | Right Lobe Transverse - inferior (lower pole) |
| 4 | Right Lobe Sagittal - lateral |
| 5 | Right Lobe Sagittal - mid |
| 6 | Right Lobe Sagittal - medial |

With regard to Table 1, a sequence order may be selected in accordance with a user's selection or may be selected automatically. Further, the system may include a plurality of Tables which may include an image name/identification and/or sequence order such that a Table in accordance with a selected exam type may be selected. For example, a user may select a Thyroid exam, or an examination of another region or organ.

With regard to caliper inputs, a user may enter caliper information after any image is acquired. Accordingly, if it is determined that a user has requested a caliper mode, the process may enter a caliper input mode. When in the caliper input mode, caliper information may be manually entered and thereafter associated by the system with the corresponding image. Further, an image sequence may be modified/changed by the system so that, images may be acquired in a modified sequence in which an image (e.g., a next image) that corresponds with, and is orthogonal to, a most recent image may be obtained immediately after the most recent image has been acquired. An image sequence may be changed by the system by, for example, determining a most recent image and using a look up table to determine a next image and/or a new image sequence as shown in Table 2A below.

TABLE 2A

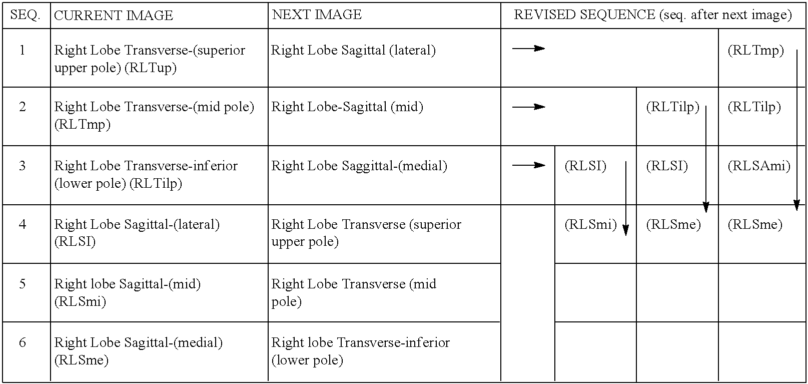

TABLE 2B

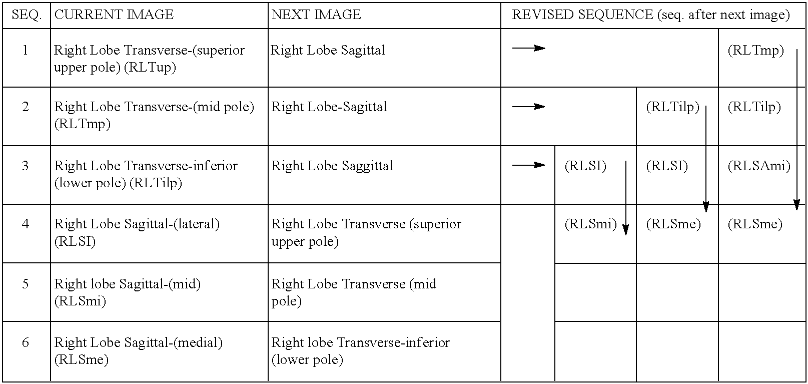

Referring back to act 210, after current image information is acquired, the process may continue to act 214.

In act 214, the process may determine contour information for the past and/or current image information using any suitable method. For example, the process may determine contour information using a digital signal processing (DSP) or image processing program such as, for example, QLAB™, etc. The contour information may include information such as, for example, topographical information, information related to contours in the images, location information (e.g., x, y, and/or z coordinate information), caliper information, user entered data (e.g., user entered caliper information, etc.), velocity information from Doppler techniques, echo intensity, etc. Further, the system may extrapolate the contour information from image information such that backward and/or multiple system compatibility can be assured. Accordingly, if one or more image parameters of the current image information do not initially match corresponding parameters in the previous image information, the system may extrapolate the required information using information such as, other image parameter information, contour information, location information, etc. Thus, for example, using caliper data such as, for example, x, y, and/or z coordinates, corresponding with previous image information, a relative location and/or size of a lesion defined by the x, y, and z coordinates may be determined (such that a desired match may be obtained) using extrapolation. The location information may correspond with a location and/or area of, for example, an abnormality such as a lesion, or a node. Further, the location information may include absolute location information contours, image frames in a corresponding plane (e.g., an x, y, and/or z plane), etc. Moreover optionally, the system may also change positions in orthogonal views (e.g., from an upper pole to a mid in orthogonal planes), as desired.

According to another embodiment of the present system, when a sagittal view is selected due to a caliper request, a general location may be used instead of, for example, a specific location (e.g., lateral, mid, or inferior locations). Thus, the system or a user may determine whether to use a general or a specific location. Accordingly, when a current image is a transverse view (e.g., a Right Lobe Transverse (superior upper pole, a midpole, and/or an lower pole)), and the user selects a caliper input, the system may select a Right Lobe Sagittal Image to be a next image as shown in Table 2B.

In other embodiments, before determining image contour information, the process may determine whether image contour information exists for past and/or current image information. Accordingly, if it is determined that image contour information does not exist for the past and/or current image information, the process may determine image contour information corresponding to the image information (e.g., past and/or current image information) for which the contour information does not exist. However, if it is determined that image contour information does exist (e.g., when image contour information has been previously saved in a database, etc.), the system may use the existing image contour information which can save time and/or resources.

After act 214, the process continues to act 216.

In act 216, the process correlates the image contour information for the past and current image information. Thus, for each image in the current image information, the process may correlate a corresponding image (or images) in the past image information. For example, the process may correlate image information corresponding with an image of a Right Lobe Transverse—superior (upper pole) view of the current image information, with information corresponding with an image of a Right Lobe Transverse—superior (upper pole) view of the past image information, and may correlate a image information corresponding with an image of a Right Lobe Sagittal—lateral view of the current image information, with information corresponding with an image of a Right Lobe Sagittal—lateral view of the past image information, etc. Further, the process may correlate image information in a three dimensional (3D) volume, if desired. Thus, elements contained in a first plane may be correlated with the element in one or more other planes, such as orthogonal planes which are to the first orthogonal plane.

After act 216, the process continues to act 218.

In act 218, the process may compare correlated current image information and previous image information and may determine whether there any changes between the previous and current image information. For example, changes may include a new lesion (e.g., a lesion that did not exist in the previous image information) in the current image information, a change in the size and/or shape of a contour, such as the contour of a lesion, a change in a location/feature, etc.

Accordingly, upon determining that a change exists, the process may form and/or associate change information with corresponding image information and store the change information for further use. The change information may be associated with an image and/or with a corresponding part of an image which has changed. Thus, for example, if an image (e.g., a Right Lobe Sagittal—mid image) includes multiple lesions, the change information may be associated with, and or indicate, lesions in the image whose size has changed. Further, the change information may be linked to other images in which the same lesion (or other point of interest) appears. Thus, for example, if it is determined that a lesion has changed in size in a first view (e.g., a Right Lobe Transverse—superior (upper pole) view) but has not changed in an orthogonal view (e.g., a Right Lobe Sagittal—lateral view), the system may associate the change information with the same lesion in the orthogonal view and may also include information indicating the view associated with the change such as, for example, a link to a corresponding orthogonal view, etc.

A weighing factor may be used in the determination of whether a change exists. For example, if an area of a lesion has changed by more than a predetermined amount (e.g., 5, 10, 15, . . . 100% or other values) in the current image information when compared to the previous image information, the system may determine that a change exists. The weighing factor may be set to a default value, set by the system depending upon a type of exam (e.g., a thyroid exam), and/or set by the user.

However, if it is determined that a change does not exist in the correlated image information, the process may associate information indicating that there is no change with corresponding image information and store the change information for further use. After act 218, the process may continue to act 220.

In act 220, the process may associate highlight information with the current image information and/or the past image information based upon the determined change information. Accordingly, the process may associate, for example, a red highlight with a frame that surrounds image in which it was determined that certain type of change is present. For example, if it is determined that the coordinates of a lesion do not match, the frame which surrounds an image of the lesion, may be highlighted in red. Similarly, if the contour of a particular feature in the current image information, such as, for example, a lesion, are determined to have changed, the process may associate a highlight (e.g., a red frame) with the particular feature in the current image information.

Further, according to an embodiment of the present system, the highlight information may correspond with predetermined optional highlight settings that may be set by a user, a manufacturer, etc. For example, according to an embodiment of the present system, if a new abnormality, such as, for example, a lesion is determined to exist in the current image information, the process may highlight the abnormality using a highlight which corresponds with highlight settings set forth in Table 3 below.

TABLE 3

| | | | | | | | High- |
|---|---|---|---|---|---|---|---|
| | | | | | | High- | light |
| | High- | High- | | | | light | lesion |
| Change/ | light | light | Frame | Lesion | Disp. | orth. | in orth. |
| size | frame | lesion | Color | Color | Delta | frame | frame |
| new lesion | Yes | yes | orange | red | Yes | yes | yes |
| <0.01 mm | Yes | yes | red | yellow | No | yes | yes |
| >0.01 mm | Yes | yes | red | red | Yes | yes | yes |
| no change | Yes | yes | yellow | yellow | No | yes | yes |
| no lesions | Yes | no | green | no | No | no | no |
| found in | | | | | | | |
| frame | | | | | | | |
| no corres. | No | yes | gray | red | no | yes | yes |
| Image | | | | | | | |

With reference to the settings in Table 3, if a new lesion is determined to exist in a current image, the process may refer to Table 3 to determine, for example, to highlight the current image using an orange highlight frame around the image and highlight a region around the lesion (e.g., in a display frame) using a red highlight. The process may also display a change in the size of region (e.g., delta) if the “Disp. delta” setting is set. Further, the system may highlight orthogonal frames which correspond to the current frame (e.g., using the same or other predetermined settings) and may selectively highlight the same lesion in other frames, as desired. Further, the “no corres. image” (i.e., no corresponding image) option may be used when a current image includes an image which does not correspond with an image in previous image information. Accordingly, if the process determines that a current image does not have a corresponding image in the previous image information, the system may highlight a frame of the current image in, for example, gray (or other system or user selected color) to inform the user of such. Thus, if the previous image information does not include an image of, for example, a Right Lobe Sagittal—lateral view, a frame around the perimeter of a Right Lobe Sagittal—lateral view, may be highlighted using, for example, a gray frame, or other defined color and/or pattern. Further, the system may use multiple frames around an image. Accordingly, an image view type (e.g., a Right Lobe Sagittal—lateral view) may be indicated by using a first frame of a predetermined color (e.g., blue, etc.) and a second frame or cross-hatching may indicate highlight information.

After act 220, the process continues to act 222.

In act 222, the process may output (e.g., via a screen display, a speaker, etc.) current image information in accordance with the change information, highlight information, caliper information, and/or image contour information for a user's review. The process may then continue to act 224.

In act 224, the process may generate a report including the current image information which may include associated labels, image acquisition parameters, contour information, caliper information, change information, highlight information, and/or annotations (e.g., input by a user, the system, etc.), etc., for review by a user. The report may also be generated before act 222, and may be edited by, for example, a user and/or the system in response to a user input or change.

In act 226, the process may save the report including current image information, associated labels, image acquisition parameters, contour information, caliper information, change information, highlight information, and/or annotations (e.g., input by a user, the system, etc.), etc. This information may be saved in, for example, a database in a local and/or remote storage device accessible via a network. Further, the report may be saved with corresponding patient identification (ID). The patient ID may include patient biometric information such as, for example, fingerprint data, iris information, etc., so that the report may be recalled at a later time by, for example, scanning a patient's fingerprint.

After act 224, the process may continue to act 228 where the process may end.

In act 230, image parameters may be set according to settings which may be set by default, a user, a user profile, etc. After completing act 230, the process may continue to act 232.

In act 232, current image information may be acquired. As this act is similar to act 210, for the sake of clarity, a further description of this act will be omitted. After completing act 232, the process may continue to act 234.

In act 234 the process may determine image contour information. This act may be similar to act 214, however, image contour information may only be determined for current image information as opposed to previous image information. Accordingly, for the sake of clarity, a further description of this act will be omitted. However, this act may be skipped, if desired, to save system resources. After completing act 230, the process continues to act 236.

In act 236, the process may output (e.g., via a display, a speaker, etc.) the current image information in accordance with the contour and/or caliper information. Accordingly, if a lesion was found in an image, a frame surrounding the image may be highlighted in, for example, red or other highlight. Further, identification information may be superimposed upon, or adjacent to, lesions that are located in the image. After completing act 236, the process may continue to act 238.

In act 238, the process may generate a report which may be similar to the report generated in step 224, however, this report may not include previous image information and/or associated information, or previous image information data fields may be left blank, in the report. After completing step 238, the process may continue to act 226.

According to one aspect of the present system, various aspects such as, for example, contour information relating to an image may be determined using conventional digital signal processing (DSP) methods. For example, a data processing program or application such as, for example, QLAB™, etc., may be used to analyze the current image information and/or the previous image information and/or determine desired topographical information such as, for example, location information, contour information, peak information, caliper information, etc., for image information in one or more of the current image information and the past image information. After the desired topographical information is determined, the system may correlate the topographical information from the current and the past image information and determine various information such as, for example, whether a new lesion has been found, whether an existing lesion has become smaller, whether an existing lesion has grown, a rate of growth for a particular lesion or nodule, whether a peak has shifted, etc. This information may then be output for a user's review and/or saved for later use.

The process may use two dimensional (2D) image information to generate a virtual three dimensional (3D) volume and/or may use 3D information to generate 3D volume information.

With regard to using 2D information, the process may associate image information that includes information related to orthogonal planes such as, for example, a Right Lobe Transverse—superior (upper pole) and a Right Lobe Sagittal—lateral view images, with each other so as to build a virtual three dimensional (3D) volume. Accordingly, two or more planar views each of which corresponds with a different image plane, may be used to create, for example, virtual three-dimensional (3D) images. Further, a method according to the present system may process two- or three-dimensional information received from, for example, an image acquisition probe to form 3D volumes of data which may be stored in, for example, a suitable memory for later analysis of required planes using an automated process. The process may use software (or computer readable instruction embodied or saved in a computer readable medium for execution by a processor or controller) to match corresponding volumes and determine whether, for example, a nodule has changed in size. Also if a change in size is detected, the system may highlight that nodule (or a frame about the nodule) using, for example, a red tint, when an image including the nodule is displayed. Conversely, if it is determined that the size of a nodule has not changed, the system may highlight that nodule using, for example, a green tint when it is displayed. This may provide a visual reference to a user for easy recognition of nodules which have grown. Accordingly, this may allow a radiologist to conveniently analyze a particular nodule using a visual aid. Further, because analysis may be performed in less time than conventional methods, patient care may be enhanced. The tint may correspond with an area of the nodule, an area about a periphery of the nodule, and/or a frame of an image containing the nodule. Further, the tint may have a pattern such as for example, a cross-hatch pattern which may be included in a frame about an image including a nodule that is to be highlighted.

A screen shot 300 illustrating an image display according to the present system is shown in FIG. 3. The screen shot 300 illustrates a screen 304 which may be displayed using data which may correspond with a right lobe of a thyroid. The screen shot 300 may also correspond with data that may be saved in a report. This data may include acquired image information, notes, annotations, measurements, day, date, time, patient's identification (ID), such as, for example, a number, a name, etc., medical professional data (e.g., sonographer's name, doctor's name, medical center's name, location, patient biometric information, etc.), viewing/editing history, change information, etc. The screen shot 300 may include one or more information areas 308 in which user information, location (e.g., “Test Hospital”), day, date, time, type of exam (e.g., “THY”) and/or certain test parameters are displayed. An image viewing area 302 may display one or more images such as, for example, images 306-1 to 306-3 which may have been acquired during a process (e.g., an image acquisition process, a download process, etc.) of an embodiment of present system. Each of the images 306-1 to 306-3 may be surrounded by a frame 310 which may be used to delineate and/or highlight an image and/or indicate a plane of view. For example, a highlight of a first color (red) may be used to indicated an image in an x plane, a highlight of a second color (green) may be used to indicate an image in a y plane, and a highlight in a third color (blue) may be used to indicate a color in a z plane. A highlight of a contrasting color or an inner frame of a different color may be used to indicate the presence of an abnormality, etc.

Although not shown, a small image (or likeness) of each of the other images 306-1 to 306-3 may be displayed in a smaller format (e.g., as icons) for a user's convenience in selecting images. This may be useful when all images corresponding with a certain examination may not be displayed in the viewing area. Accordingly, a user may select one of the smaller images to view as an enlarged rendering of the selected image. Thus, by selecting an image (e.g., using a double click of a mouse, etc.), a user may cause the process to magnify the image. Further, a magnification view setting may be provided so that, selected views may be displayed in a window that may be larger than windows which display the other images (e.g., smaller views, icons, etc.). Further, as shown, when an abnormality such as a lesion is detected by the process, the abnormality may be automatically assigned an identifier (ID) 312-3 and other information. This information may be displayed in association with an image and may be included in the image information and saved for later use. Further, highlight information may be selectively superimposed upon an image. Accordingly, the image may be viewed in its entirety and then, when, for example, a user requests that highlight information be superimposed upon the image (e.g., via a menu selection), highlight information for that image or other images in the same image sequence may be selectively superimposed upon the image.

A screen shot 400 illustrating another image display according to the present system is shown in FIG. 4. The screen shot 400 may be similar to the screen shot 300, however the screen shot 400 illustrates images which may correspond with a left lobe of a thyroid.

A screen shot 500 illustrating a further image display according to the present system is shown in FIG. 5. The screen shot 500 illustrates image 506 which is a detailed image which corresponds with image 306-1 of FIG. 3. A focal zone location indicator bar 512 may be displayed on the screen where a user may change it, e.g., via any user input device, such as a keyboard, mouse, or a pointer touching the screen in case of a touch sensitive screen. The user may also adjust the image intensity/contrast via selection 514. Of course, any other desired indictors or selection bars may be displayed as desired to provide further user control, such as a scroll/location bar so that the user may scroll the image. After inputting a user's selection, the image 506 and the corresponding image information such as, for example, annotations, caliper information, and/or other information may be saved for later use and review.

A screen shot 600 illustrating yet another image display according to the present system is shown in FIG. 6. The screen shot 600 illustrates image 606 which is a detailed image which corresponds a view of an isthmus of the thyroid shown in FIGS. 4-5. After inputting a user's selection, image 606 and the corresponding information such as, for example, annotations, caliper information, and/or other information may be saved for later use and review.

Although not shown, the screens 300, 400, 500, and/or 600 may also illustrate user selections which may include, for example, icons or menu items which may be selected by the user to, for example, scan, file, print, transfer images (e.g., from one display to another), mute, transcribe, and/or use a headpiece, as desired. Further, one or more menus as is known in the art may be provided for a user's convenience. The displayed images and associated data may be saved at any time during the process shown in FIGS. 1A and 2. However, a history mode may be activated to gather information indicative of when data may have been added and/or edited so that a user may refer back to original information and/or determine when and/or who made certain changes to information which may be saved in, for example, a generated report. Further, the changes may also be stored for later use.

Thus, according to the present systems and devices, an accurate, convenient, low-cost, upgradeable, reliable, and standardized imaging system is provided.

Although the present system has been described with reference to a thyroid ultrasound imaging system, it is also envisioned that the present system can be extended to other medical imaging systems where multiple images are obtained in a systematic manner. Accordingly, the present system may be used to obtain and/or record image information related to renal, testicular, breast, ovarian, uterine, thyroid, hepatic, splenic, heart, arterial and vascular system, as well as other imaging applications. Further, the present system may also include or more programs which may be used with conventional imaging systems so that they may provide features and advantages of the present system.

Further, the present systems, apparatuses, and methods, may also be extended to any small parts imaging where the clear landmarks can be defined and reproduced. Further, the present methods, may be embedded in a program code which may be applied to existing imaging systems such as, for example, ultrasonic imaging systems. Suitable ultrasonic imaging systems may include a Philips™ ultrasound system which may, for example, support a conventional VLI3-5™ broadband liner array that may be suitable for small-parts imaging. Further, analysis techniques such as, for example, QLAB™ may be available on-cart with an imaging apparatus or as a post-processing program which may be run outside of an examination room. Further, multiple nodules, anatomical entities such as follicles, or other detectible objects, may be followed using the present system. Further, the method of the present systems may be applied to volumes acquired using transducers such as, for example, calibrated 3D transducers, which may include, for example, X-matrix™ or mechanical transducers.

Certain additional advantages and features of this invention may be apparent to those skilled in the art upon studying the disclosure, or may be experienced by persons employing the novel system and method of the present invention, chief of which is that a more reliable image acquisition system and method of operation thereof is provided. Another advantage of the present systems and method is that conventional medical image systems can be easily upgraded to incorporate the features and advantages of the present systems, devices, and methods.

Of course, it is to be appreciated that any one of the above embodiments or processes may be combined with one or more other embodiments and/or processes or be separated and/or performed amongst separate devices or device portions in accordance with the present systems, devices and methods.

Finally, the above-discussion is intended to be merely illustrative of the present system and should not be construed as limiting the appended claims to any particular embodiment or group of embodiments. Thus, while the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

In interpreting the appended claims, it should be understood that:

a) the word “comprising” does not exclude the presence of elements or acts other than those listed in a given claim;

b) the word “a” or “an” preceding an element does not exclude the presence of a plurality of such elements;

c) any reference signs in the claims do not limit their scope;

d) several “means” may be represented by the same item or by the same hardware- or software-implemented structure or function;

e) any of the disclosed elements may be comprised of hardware portions (e.g., including discrete and integrated electronic circuitry), software portions (e.g., computer programs), and any combination thereof;

f) hardware portions may be comprised of one or both of analog and digital portions;

g) any of the disclosed devices or portions thereof may be combined or separated into further portions unless specifically stated otherwise;

h) no specific sequence of acts or steps is intended to be required unless specifically indicated; and

i) the term “plurality of” an element includes two or more of the claimed element, and does not imply any particular range or number of elements; that is, a plurality of elements may be as few as two elements, and may include an immeasurable number of elements.

1. A medical imaging system, comprising at least one controller configured to:
receive first image information corresponding with one or more images acquired at a first time;
receive second image information corresponding with one or more images acquired at a second time, previous to the first time;
determine whether first coordinate information corresponding to one or more locations in the first image information has changed relative to second coordinate information corresponding to one or more locations in the second image information; and
highlight the first image information based upon a result of the determination, wherein the controller is further configured to associate a first highlight with the first image information when it is determined that the first coordinate information corresponding to one or more locations of an abnormality in the first image information has changed relative to the second coordinate information corresponding to one or more locations of the abnormality in the second image information, wherein the controller is further configured to associate a second highlight different from the first highlight with the first image information when it is determined that that the first coordinate information corresponding to one or more locations of an abnormality in the first image information that has not changed relative to second coordinate information corresponding to one or more locations of the abnormality in the second image information.

2. The imaging system of claim 1, further comprising an ultrasonic probe configured to acquire information related to the first image information.

3. The imaging system of claim 1, wherein the one or more images in the first image information comprises a sequence of images having at least two images which correspond with planes that are orthogonal to each other.

4. The imaging system of claim 1, wherein the one or more images acquired at the first time and/or the second time corresponds with a sequence of images.

5. (canceled)

6. The imaging system of claim 1, wherein the controller is further configured to determine coordinate information corresponding to the one or more locations in the first image information and/or the second image information.

7. The imaging system of claim 6, wherein the coordinate information is based upon calculated image contour information.

8. The imaging system of claim 1, wherein the controller is further configured to determine a rate of growth of one or more of one or more locations in the first image information.

9. (canceled)

10. (canceled)

11. An image processing method performed by one or more controllers, the method comprising the acts of:
receiving first image information corresponding with a one or more images acquired at a first time;
receiving second image information corresponding with one or more images acquired at a second time, previous to the first time;
determining whether first coordinate information corresponding to one or more locations in the first image information has changed relative to second coordinate information corresponding to one or more locations in the second image information; and
highlighting the first image information based upon a result of the determination, further comprising the act of associating a first highlight with the first image information when it is determined that the first coordinate information corresponding to the one or more locations of an abnormality in the first image information has changed relative to the second coordinate information corresponding to the one or more locations of the abnormality in the second image information, still further comprising the act of associating a second highlight, different from the first highlight, with the first image information when it is determined that the first coordinate information corresponding to one or more locations of an abnormality in the first image information has not changed relative to second coordinate information corresponding to one or more locations of the abnormality in the second image information.

12. The image processing method of claim 11, further comprising the act of acquiring information related to the first image information from an ultrasonic probe.

13. The image processing method of claim 11, wherein the one or more images acquired at the first time correspond with a first sequence of images, and the one or more images acquired at the second time correspond with a second sequence of images.

14. The image processing method of claim 11, further comprising the act of generating a three dimensional image volume using information from two or more images which correspond with planes that are orthogonal to each other, the two or more images being selected from the one or more images acquired at the first time or the one or more images acquired at the second time.

15. (canceled)

16. The image processing method of claim 11, further comprising the act of determining coordinate information corresponding to the one or more locations in the first image information and/or the second image information.

17. The image processing method of claim 11, further comprising the act of calculating image contour information.

18. The image processing method of claim 11, further comprising the act of determining a rate of growth of the one or more locations in the first image information.

19. (canceled)

20. (canceled)

21. An application embodied on a computer readable medium configured to receive image information from an ultrasonic probe, the application comprising:
code which causes a controller to:
receive first image information corresponding with one or more images acquired at a first time;
receive second image information corresponding with one or more images acquired at a second time, previous to the first time;
determine whether first coordinate information corresponding to one or more locations in the first image information has changed relative to second coordinate information corresponding to one or more locations in the second image information; and
highlight the first image information based upon a result of the determination, wherein the code controls the controller to associate a first highlight with the first image information when it is determined that the coordinate information corresponding to one or more locations of an abnormality in the first image information has changed relative to coordinate information corresponding to one or more locations of the abnormality in the second image information, wherein the code further controls the controller to associate a second highlight, different from the first highlight, with the first image information when it is determined that that the first coordinate information corresponding to one or more locations of an abnormality in the first image information has not changed relative to the second coordinate information corresponding to one or more locations of the abnormality in the second image information.

22. (canceled)

23. (canceled)
